(19) United States
(12) Patent Application Publication
(10) Pub. No.: US 2025/0200238 A1
(43) Pub. Date: Jun. 19, 2025

(54) MODEL LEARNING SYSYEM AND METHOD FOR CAR BODY DEVELOPMENT

(71) Applicants: HYUNDAI MOTOR COMPANY, Seoul (KR); KIA CORPORATION, Seoul (KR)

(72) Inventor: Kyu Hwan Oh, Hwaseong-si (KR)

(73) Assignees: HYUNDAI MOTOR COMPANY, Seoul (KR); KIA CORPORATION, Seoul (KR)

(21) Appl. No.: 18/968,716

(22) Filed: Dec. 4, 2024

(30) Foreign Application Priority Data
Dec. 13, 2023 (KR) 10-2023-0180253

(51) Int. Cl. G06F 30/15; G06F 30/27

(52) U.S. Cl. CPC G06F 30/15; G06F 30/27

(57) ABSTRACT

A model learning system and a method for car body development are disclosed. The model learning system includes a data acquisition module configured to acquire data for performing learning of a model for car body development. The model learning system also includes a model learning module configured to perform the model learning by using the acquired data. The model learning system further includes a target area setting module configured to set a target area from a result of the model learning. The model learning system further includes a loss function improvement module configured to improv a loss function based on the target area. The model learning system further still includes an optimal specification derivation module deriving an optimal specification for a car body in development by using the model learned based on the improved loss function.

### CROSS-REFERENCE TO RELATED APPLICATION

This application claims priority to and the benefit of Korean Patent Application No. 10-2023-0180253, filed in the Korean Intellectual Property Office on Dec. 13, 2023, the entire contents of which are hereby incorporated herein by reference.

### BACKGROUND

### (a) Field

The present disclosure relates to a model learning system and a method for car body development.

### (b) Description of the Related Art

A general operational flow of an artificial intelligence system may include several steps, such as a data collection step, a data preprocessing step, a model designing step, a model learning step, a model evaluation step, a hyperparameter tuning step, and/or the like. The artificial intelligence system may collect data necessary for learning and evaluation of an artificial intelligence model in the data collection step and may convert the collected data into a form suitable for the model learning in the data preprocessing step. In the model learning step, the artificial intelligence system may use preprocessed data to learn a designed model based on an appropriate algorithm or architecture. Such learning may be mainly done by updating a weight of the model. In general, neural network learning may be a process of finding the minimum point of a loss function. Neural network learning may have an ultimate goal of learning a given data set to accurately predict a target value.

However, when developing a car body of a vehicle, it is often difficult to secure a large amount of data for the neural network learning, and a goal of the learning is often to acquire an optimal specification for designing the car body unlike a general artificial intelligence technique whose goal is to output an accurate predicted value for an arbitrary input value.

### SUMMARY

Therefore, there is a need for a specialized artificial intelligence technique for deriving an optimal specification.

Embodiments of the present disclosure provide model learning system and method for car body development capable of acquiring an optimal specification for designing a car body based on a small amount of data by acquiring a desired target area based on minimum data and redefining a loss function in a target area.

According to an embodiment, a model learning system for car body development is provided. The model learning system includes a data acquisition module configured to acquire data for performing learning of a model for car body development. The model learning system also includes a model learning module configured to perform the model learning by using the acquired data. The model learning system additionally includes a target area setting module configured to set a target area from a model learning result The model learning system further includes a loss function improvement module improving a loss function based on the target area. The model learning system further still includes an optimal specification derivation module configured to derive an optimal specification for a car body in development by using the model that completes its learning based on the improved loss function.

The data acquisition module may be configured to acquire data around the optimal specification to perform the learning of the model for car body development.

The target area setting module may be configured to set, as the target area, an area in a range of ±2ΔNRMSE (normalized root mean square error) from the model learning result.

The target area setting module may be configured to set a first target area for a first model predicting a fracture area of a center pillar during vehicle collision. The target area setting module may also be configured to set a second target area for a second model predicting an invasion depth for the center pillar during the collision.

The loss function improvement module may be configured to improve the loss function for the first model based on the first target area. The loss function improvement module may also be configured to improve the loss function for the second model based on the second target area.

The center pillar may be manufactured by combining a plurality of layers of materials.

The data acquisition module may be configured to secure additional data adjacent to a desired target after the target area is set by the target area setting module.

The model learning and the loss function improvement may be performed in parallel with each other.

According to another embodiment, a model learning method for car body development is provided. The model learning method includes acquiring data for performing learning of a model for car body development. The model learning method also includes performing the model learning by using acquired data. The model learning method additionally includes setting a target area from a model learning result. The model learning method further includes improving a loss function based on the target area. The model learning method further still includes deriving an optimal specification for a car body in development by using the model that completes its learning based on the improved loss function.

In the acquiring of the data, data around the optimal specification may be acquired to perform the learning of the model for car body development.

In the setting of the target area, an area in a range of ±2ΔNRMSE (normalized root mean square error) from the model learning result may be set as the target area.

Setting the target area may include setting a first target area for a first model predicting a fracture area of a center pillar during vehicle collision and setting a second target area for a second model predicting an invasion depth for the center pillar during the collision.

Improving the loss function may include improving the loss function for the first model based on the first target area, and improving the loss function for the second model based on the second target area.

The center pillar may be manufactured by combining a plurality of layers of materials.

In the acquiring of the data, additional data adjacent to a desired target may be secured after the target area is set by the target area setting module.

The model learning and the loss function improvement may be performed in parallel with each other.

### BRIEF DESCRIPTION OF THE DRAWINGS

FIG. 1 is a block diagram of a model learning system for car body development according to an embodiment.

FIGS. 2-4 are diagrams for explaining operations of the model learning system for car body development according to an embodiment.

FIG. 5 is a flowchart of a model learning method for car body development according to an embodiment.

FIG. 6 is a block diagram of a computing device according to an embodiment.

### DETAILED DESCRIPTION

Hereinafter, embodiments of the present disclosure are described in detail with reference to the accompanying drawings so that those having ordinary skill in the art to which the present disclosure pertains may easily practice the present disclosure. However, the present disclosure may be implemented in various different forms and is not limited to the embodiments described herein. In addition, in the drawings, portions unrelated to the description are omitted to clearly describe the present disclosure and similar portions are denoted by similar reference numerals throughout the specification.

In the specification and the claims, unless explicitly described otherwise, the terms “comprise”, “include”, or the like, and variations such as “comprises”, “comprising”, “includes”, “including”, or the like, should be understood to imply the inclusion of stated elements but not the exclusion of any other element. Terms including ordinal numbers such as “first”, “second” and the like, may be used to describe various components. However, these components are not limited by these terms. These terms are used only to distinguish one component and another component from each other.

Terms such as “˜part”, “˜er/or”, and “module” described in the present disclosure may refer to a unit capable of processing at least one function or operation described herein, which may be implemented as hardware, a circuit, software, or a combination of hardware or circuit and software.

When a component, device, element, or the like of the present disclosure is described as having a purpose or performing an operation, function, or the like, the component, device, or element should be considered herein as being “configured to” meet that purpose or to perform that operation or function.

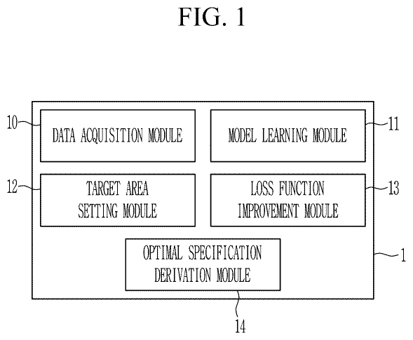

FIG. 1 is a block diagram of a model learning system for car body development according to an embodiment.

Referring to FIG. 1, a model learning system 1 for car body development according to an embodiment may include a data acquisition module 10, a model learning module 11, a target area setting module 12, a loss function improvement module 13, and an optimal specification derivation module 14.

The data acquisition module 10 may acquire data for performing learning of a model for car body development. The model may be a model for deriving an optimal specification for collision performance of a center pillar of a vehicle having a combination of materials, for example. The center pillar may refer to a structure supporting a roof of a car body. The center pillar may be an important structural part of the car body that absorbs impact energy when a side collision occurs to thus prevent another vehicle from invading a passenger space. In an example, the center pillar may be manufactured by combining 56 layers of materials and may include a total of 56 divided areas. For example, the areas may include a top area, a sidewall area, a corner area, a flange area, and/or the like. The model may predict specifications for a fracture area and an invasion depth as the optimal specifications. When implemented, the model may include, for example, a single-layer neural network for modeling a linear relationship between data features or a deep neural network having multiple hidden layer structures and non-linear activation functions.

The data acquisition module 10 may acquire only data around the optimal specification to perform the learning of the model for car body development. Accordingly, the data acquisition module 10 may acquire a significantly smaller amount of data than an amount of data required for the model learning in a typical artificial intelligence technique that outputs a predicted value for an arbitrary input value. In order to derive the optimal specification for the collision performance of the center pillar, it is desired to configure the data around the optimal specification as intensive learning data rather than using data of an arbitrary range as learning data to acquire each predicted value for every input value. In particular, it is desired to use the data around the optimal specification instead of the data of the arbitrary range in order to solve difficulties in securing a large amount of data on the center pillar. For example, when at least 2,500 data points of the arbitrary range is required for the model learning, the data acquisition module 10 may identify an overall trend by acquiring only about 50 data points. The data acquisition module 10 may then define a range of variables that includes the optimal specifications. In addition, the data acquisition module 10 may acquire the data around the optimal specification by adding a small amount of data to the range.

The model learning module 11 may perform the model learning based on the data around the optimal specification acquired by the data acquisition module 10. In an example, the model learning module 11 may perform the learning of a first model for predicting the fracture area of the center pillar during the collision and a second model for predicting the invasion depth for the center pillar during the collision, based on the data around the optimal specification. The model learning module 11 may evaluate learning performance of the model by using a NRMSE normalized root mean square error (NRMSE) as an indicator. NRMSE is a variation of root mean square error (RMSE). NRMSE may be an indicator that normalizes a prediction error of the model. The model learning module 11 may compare the prediction performances between various problems or data sets more intuitively by normalizing the error. In some embodiments, NRMSE may have a value between zero and 1 obtained by performing calculation of dividing RMSE by a range of observed values (e.g., the maximum of the observed values minus the minimum thereof). The closer the value is to zero, the better the prediction performance of the model.

In an example, after performing the learning by the model learning module 11, the model may show its learning performance as follows. In this example, the learning is performed using about 50 data points.
First model with NRMSE=0.226±0.016.
Second model with NRMSE=1.101±0.026.

For comparison, when performing the learning by using about 2,500 data points, the model may be expected to show the following performance.
First model with NRMSE=0.073±0.003.
Second model with NRMSE=0.512±0.012.

At a current stage, the model may achieve numerically superior performance when performing its learning by using a lot of data. However, as described above, the method of performing the learning by using sufficient data may be difficult to be applied to or may be less efficient in the car body development. As described in more detail below, the model may achieve the same level of accuracy by using only about 50 data points as that achieved when performing its learning by using about 2,500 data points by setting a target area as an optimal area from a result derived by the model learning module 11, redefining a loss function, and performing additional learning by adding the small amount of data selected in the target area.

The target area setting module 12 may set the target area from a result of the model learning performed by the model learning module 11. In an example, the target area setting module 12 may set, as the target area, an area in a horizontal axis range of ±2ΔNRMSE from the model learning result to limit a range of a difference between the predicted value and an actual value. For example, when assuming that the first model has ΔNRMSE of 0.032, the target area setting module 12 may set, as the target area, an area corresponding to a range of an indicator value on the horizontal axis from −0.032 to 0.032 from an artificial intelligence prediction result made for certain data.

In some embodiments, the target area setting module 12 may set a first target area for the first model for predicting the fracture area of the center pillar during the collision and may set a second target area for the second model for predicting the invasion depth for the center pillar during the collision.

The loss function improvement module 13 may improve the loss function based on the target area set by the target area setting module 12. As described above, the model learning module 11 may perform the model learning by using the data around the optimal specification acquired by the data acquisition module 10. In this process, the model learning module 11 may define the loss function for measuring the difference between the predicted value and the actual value. The data acquisition module 10 may update a model parameter to minimize a value of the loss function. The loss function improvement module 13 may improve a corresponding loss function used in relation to the operation of the data acquisition module 10 to a loss function based on the target area set by the target area setting module 12. The model learning module 11 may conduct its learning to minimize the value of the improved loss function. As the model learning is performed based on the improved loss function, the learning may be performed in a reduced area, thus making the model to easily secure its high accuracy by using only the small amount of data. This method is distinct from the method that requires a large amount of data to increase accuracy of the loss function defined in an entire area.

In an example, the loss function improvement module 13 may improve the loss function for the first model for predicting the fracture area of the center pillar during the collision based on the first target area and may improve the loss function for the second model for predicting the invasion depth for the center pillar during the collision based on the second target area.

The optimal specification derive module 14 may derive the optimal specification for a car body in development by using the model learned based on the loss function improved by the loss function improvement module 13. In an example, the optimal specification derivation module 14 may derive the optimal specification for the fracture area by using the first model learned based on a first loss function improved by the loss function improvement module 13 and may derive the optimal specification for the invasion depth by using the second model learned based on a second loss function improved by the loss function improvement module 13. Further, the optimal specification derivation module 14 may derive, from these optimal specifications, another optimal specification for the stiffness or collision of the center pillar at an equivalent weight level.

According to embodiments, the model learning system and method for car body development may acquire the optimal specification for designing the car body based on the relatively small amount of data by acquiring the desired target area based on the minimum data, which is significantly smaller amount than the amount of data required for the typical model learning, and redefining the loss function in the target area.

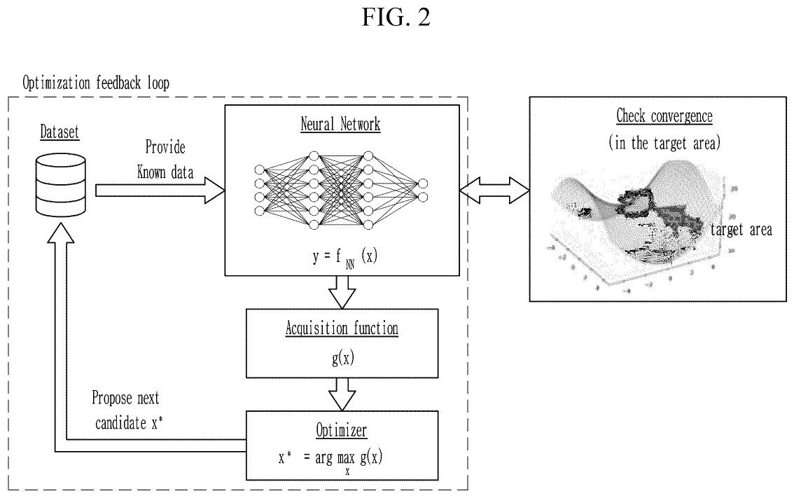

FIGS. 2-4 are diagrams for explaining operations of the model learning system for car body development according to an embodiment.

Referring to FIG. 2, an optimization feedback loop may be implemented by the model learning system. The model may be provided with correct answer data selected from the data set and may learn a neural network expressed as y=f_{NN}(x). Learning the neural network may be performed in parallel with setting the target area and the improvement of the loss function for the target area. After changing the loss function based on the target area, the model learning system may improve accuracy of the target area by updating an optimal value.

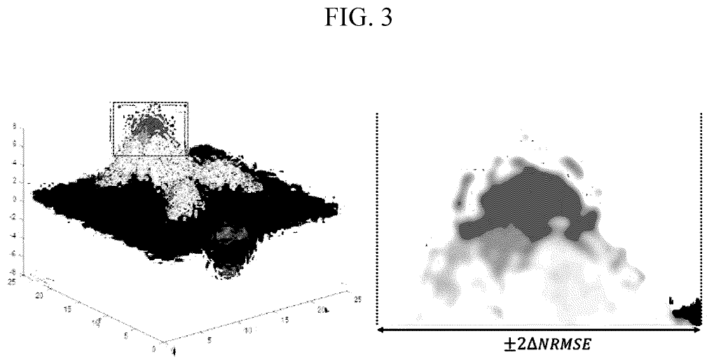

FIG. 3 shows that the model learning system sets, as the target area, an area in the range of ±2ΔNRMSE on the horizontal axis when setting the target area from the model learning results. In addition, the model learning system may re-evaluate the learning performance of the model by using NRMSE whenever setting the target area.

In the model learning system 1 for car body development according to an embodiment, the data acquisition module 10 may secure additional data adjacent to a desired target after the target area is set by the target area setting module 12. For example, the data acquisition module 10 may secure additional data such as the stiffness, cost, or the like of the center pillar. These data may be used during the model learning to further improve the prediction accuracy of the model through an optimization update.

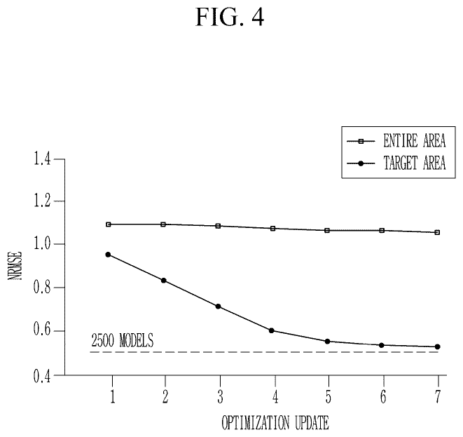

Referring to FIG. 4, NRMSE for the entire area indicates a case where the data of the arbitrary range is used as the learning data. Further, NRMSE for the target area indicates a result of learning performed based on the method described above that uses the data around the optimal specification. It may be seen securing the additional data adjacent to the desired target after the target area is set by the target area setting module 12 results in an improved accuracy as the number of optimization updates is increased in the case of the NRMSE for the target area, where the learning is performed based on the method described above that uses the data around the optimal specification while having no significant influence on the case of the NRMSE for the entire area, where the data of the arbitrary range is used as the learning data.

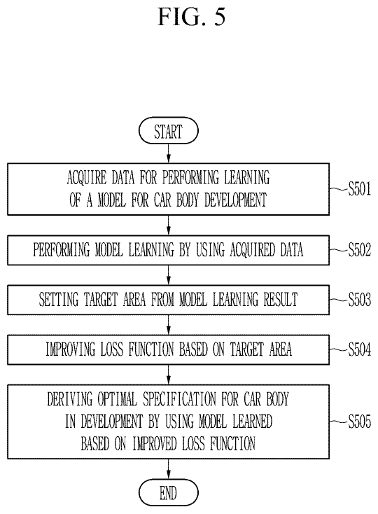

FIG. 5 is a flowchart of a model learning method for car body development according to an embodiment.

Referring to FIG. 5, the model learning method for car body development according to an embodiment may include an operation S502 of acquiring data for performing learning of a model for car body development. The model learning method may also include an operation S502 of performing the model learning by using acquired data. The model learning method may further include an operation S503 of setting a target area from a model learning result. The model learning method may further include an operation S504 of improving a loss function based on the target area. The model learning method may further still include an operation S505 of deriving an optimal specification for the car body in development by using the model that completes its learning based on the improved loss function. More detailed descriptions of the operations of the model learning method are provided above with reference to FIGS. 1-4. The description of FIG. 5 omits redundant descriptions.

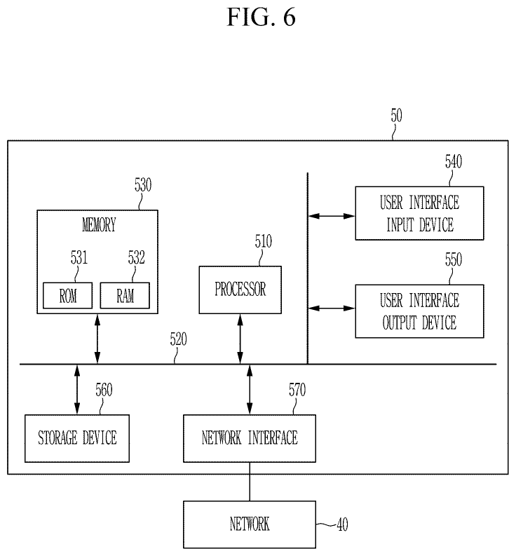

FIG. 6 is a diagram of a computing device according to an embodiment.

Referring to FIG. 6, the model learning system for car body development and method according to embodiments may be implemented using a computing device 50.

The computing device 50 may include at least one of a processor 510, a memory 530, a user interface input device 540, a user interface output device 550, and a storage device 560, that perform communications with each other by using a bus 520. The computing device 50 may also include a network interface 570 electrically connected to a network 40. The network interface 570 may transmit or receive a signal with another entity through the network 40.

The processor 510 may be implemented in any of various types such as an micro controller unit (MCU), an application processor (AP), a central processing unit (CPU), a graphic processing unit (GPU), a neural processing unit (NPU), a quantum processing unit (QPU), and/or the like. The processor 510 may be any semiconductor device executing an instruction stored in the memory 530 or the storage device 560. The processor 510 may implement the functions, operations, and methods described above with respect to FIGS. 1-5.

The memory 530 and the storage device 560 may include various types of volatile or non-volatile storage media. For example, the memory may include a read-only memory (ROM) 531 and a random access memory (RAM) 532. The memory 530 may be disposed inside or outside the processor 510. The memory 539 may be connected to the processor 510 through various means that are well-known to those having ordinary skill in the art.

In some embodiments, at least some components, operations, or functions of the model learning system and method for car body development according to embodiments may be implemented as a program or software executed by the computing device 50. The program or software may be stored in a computer-readable medium. For example, the computer-readable medium according to embodiments may store a program for executing the model learning system for car body development and the operations or steps included in the model learning method for car body development according to embodiments. The program may be recorded on a computer including the processor 510 executing the program or instruction stored in the memory 530 or the storage device 560, for example.

In some embodiments, at least some components, operations, or functions of the model learning system and method for car body development according to embodiments may be implemented using the hardware or circuitry of the computing device 50, or may be implemented using a separate hardware or circuitry that may be electrically connected to the computing device 50.

As set forth above, the model learning system and method for car body development according to embodiments may acquire the optimal specification for designing the car body based on relatively small amount of data by acquiring the desired the target area based on the minimum data and redefining the loss function in the target area.

Although embodiments of the present disclosure have been described in detail hereinabove, the scope of the present disclosure is not limited thereto. Various modifications and alterations that may be made by those having ordinary skill in the art to which the present disclosure pertains by using basic concepts of the present disclosure as defined in the following claims also fall within the scope of the present disclosure.

What is claimed is:

1. A model learning system for car body development, the model learning system comprising:
a data acquisition module configured to acquire data for performing learning of a model for car body development;
a model learning module configured to perform model learning by using the acquired data;
a target area setting module configured to set a target area from a model learning result;
a loss function improvement module configured to improve a loss function based on the target area; and
an optimal specification derivation module configured to derive an optimal specification for a car body in development by using the model learned based on the improved loss function.

2. The model learning system of claim 1, wherein the data acquisition module is configured to acquire data around the optimal specification to perform the learning of the model for car body development.

3. The model learning system of claim 1, wherein the target area setting module is configured to set, as the target area, an area in a range of ±2ΔNRMSE from the model learning result, wherein NRMSE is a normalized root mean square error.

4. The model learning system of claim 3, wherein the target area setting module is configured to:
set a first target area for a first model for predicting a fracture area of a center pillar during vehicle collision; and
set a second target area for a second model for predicting an invasion depth for the center pillar during the vehicle collision.

5. The model learning system of claim 4, wherein the loss function improvement module is configured to improve the loss function for the first model based on the first target area, and improves the loss function for the second model based on the second target area.

6. The model learning system of claim 4, wherein the center pillar is manufactured by combining a plurality of layers of materials.

7. The model learning system of claim 1, wherein the data acquisition module is configured to secure additional data adjacent to a desired target after the target area is set by the target area setting module.

8. The model learning system of claim 1, wherein model learning and improving the loss function are performed in parallel with each other.

9. A model learning method for car body development, the model learning method comprising:
acquiring data for performing learning of a model for car body development;
performing model learning by using acquired data;
setting a target area from a model learning result;
improving a loss function based on the target area; and
deriving an optimal specification for a car body in development by using the model learned based on the improved loss function.

10. The method of claim 9, wherein acquiring the data includes acquiring the data around the optimal specification to perform the learning of the model for car body development.

11. The method of claim 9, wherein setting the target area includes setting, as the target area, an area in a range of ±2ΔNRMSE from the model learning result is set, wherein NRMSE is a normalized root mean square error.

12. The method of claim 11, wherein setting the target area includes:
setting a first target area for a first model for predicting a fracture area of a center pillar during vehicle collision; and
setting a second target area for a second model for predicting an invasion depth for the center pillar during the vehicle collision.

13. The method of claim 12, wherein improving of the loss function includes:
improving the loss function for the first model based on the first target area, and
improving the loss function for the second model based on the second target area.

14. The method of claim 12, wherein the center pillar is manufactured by combining a plurality of layers of materials.

15. The method of claim 9, wherein acquiring the data includes securing additional data adjacent to a desired target after the target area is set.

16. The method of claim 9, wherein model learning and improving the loss function are performed in parallel with each other.
